(19) United States
(12) Patent Application Publication
(10) Pub. No.: US 2007/0134464 A1
(43) Pub. Date: Jun. 14, 2007

(54) Spacer fabric

(75) Inventors: Michael Schindzielorz, Kernersville, NC (US); Jimmy L. Pruitt, Hickory, NC (US); Carl Wagner, Cheraw, SC (US)

Correspondence Address: FOLEY AND LARDNER LLP;SUITE 500, 3000 K STREET NW, WASHINGTON, DC, 20007, US

(73) Assignee: HIGHLAND INDUSTRIES, INC.

(21) Appl. No.: 11/702,545

(22) Filed: Feb. 6, 2007

Related U.S. Application Data
(63) Continuation of application No. 11/030,079, filed on Jan. 7, 2005, now abandoned.
Application No. 11/030,079 is a continuation-in-part of application No. 10/829,397, filed on Apr. 22, 2004.

(51) Int. Cl. B32B 3/02; B32B 33/00

(52) U.S. Cl. 428/86

(57) ABSTRACT

A material comprises a cover layer and a porous material layer. The cover layer may include a rigid, semi-rigid or flexible material and the porous spacer material layer may include a reticulated foam, nonwoven textile, or a spacer fabric. The material is configured to have a high air flow rate upon an application of a pressure, and good compactability.

### CROSS-REFERENCE TO RELATED PATENT APPLICATIONS

This application is a continuation-in-part of application Ser. No. 10/829,397, filed Apr. 22, 2004, incorporated herein by reference in its entirety.

### BACKGROUND

The present invention relates to a spacer fabric.

Certain conventional fabrics include a padding or porous layer covered by an outer layer. The underlying padding or porous layer is typically sewn to the outer layer. The outer layer in the conventional sewn assembly may pucker or have other surface deformations resulting from the sewn seams. Additionally, in certain situations, pockets or gaps may be formed between the padding and outer layers. These problems create an undesirable appearance and may decrease the value of a seat or the object utilizing the sewn fabric. The puckering and air pockets may also create an uncomfortable surface when contacted by a person sitting or leaning against the sewn fabric.

The porous or padding layer may be a spacer fabric. The conventional covered spacer fabrics generally result in increased costs for the manufacturer. Rolls or cut pieces of the spacer fabric are produced, pre-cut, and shipped to an assembly plant. After shipment, the spacer fabric tends to lose its dimensions. As a result, the process of sewing a precut outer layer to the spacer fabric is difficult and time-consuming. Another drawback of the conventional spacer fabric is that the edges of the conventional fabric fray and lack dimensional stability.

These covered spacer fabrics have many uses such as, for example, seats, home furnishings, and shoes. Conventional spacer fabrics incorporated in seats may be found, for example, in DE 19931193 (hereby incorporated by reference herein in its entirety).

The spacer fabric is typically a padding or ventilation layer. Seats generally use spacer fabrics to cool or warm an occupant or remove perspiration. However, typical seats in spacer fabrics wear quickly and may chill or overheat an occupant due to improper air flow.

Spacer fabrics offer several advantages over other padding or ventilation layers such as, for example, foam. First, spacer fabrics are formed from textile fibers and filaments and many textile fiber and filamentary materials are recyclable. Thus, the use of spacer fabrics as a cushioning material overcomes the inability of foams to be recycled and the attendant problems associated with disposal of such materials. Also, spacer fabrics offer substantially enhanced air and moisture permeability over foams, which make such fabrics more desirable than foam materials for use in automotive and marine applications as well as home furnishing applications.

As described above, current textile technology includes spacer fabric materials with sewn on material coverings. Spacer fabrics covered with a sewn on material characteristically have the tendency for the opposing covering and spacer structures to shift and move in parallel with respect to one another. Moreover, there are inherent difficulties in mating a rigid or semi-rigid surface material (e.g. leather) with a non-rigid spacer material through a sewing process. One problem is that the dimensions of the cut pieces of spacer material tend to change size after cutting, typically shrinking in size. As a result, when the cut part of rigid or semi-rigid material is sewn around the perimeter to the cut piece of spacer fabric, the change in dimensions of the spacer material cause puckering and creasing in the rigid or semi-rigid cover layer. A large number of the sewn components have this problem. Present attempts to solve this specific problem have focused on using a more rigid, higher denier monofilament in the spacer fabric to improve the sewing performance and have not been successful. The use of a significantly heavier denier monofilament produces an uncomfortable fabric.

Other problems encountered in joining cut pieces of spacer fabric to cut pieces of a cover material include rough, jagged edges; fraying and shedding of monofilament pile; missing or misplaced notches (to guide the sewer); during sewing, the sewing needle and presser foot snag in the spacer fabric; and sewing “run off” or “raw edge” where the stitches of the joining seam do not grip the spacer fabric. The primary causes of these problems are inconsistent part dimensionality, inherent elasticity of the fabric, and jostling during transit.

An additional problem associated with such conventional fabrics are that they collapse under minimal loading. Furthermore, conventional fabrics such as reticulated foam lack the ability to transport air through the material at a sufficiently high rate to cool or warm the material.

### SUMMARY OF THE INVENTION

According to one embodiment, a material is provided. The material comprises a first fabric layer; a second fabric layer; and a pile layer extending between the first fabric layer and the second fabric layer. The pile layer is configured so that when the material is subjected to air pressure of 200 mBar, the air flow rate through the pile layer is in the range of approximately 80 to 300 cfm.

According to another embodiment, a material is provided that includes a porous material layer including a plurality of fibers extending between a pair of fabric layers. Each of the fibers has a tenacity in the range of approximately 40 to 50 cN/tex.

According to another embodiment, a material is provided that includes a porous material layer including a plurality of fibers extending between a pair of fabric layers. Each of the fibers has a diameter in the range of approximately 0.07 to 0.1 1 mm.

According to another embodiment, a material is provided that comprises a first fabric layer; a second fabric layer; and a pile layer extending between the first fabric layer and the second fabric layer. The material is configured to have a specific compactability in the range of 35 to 100 cm³.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a sectional view of a material according to an embodiment of the present invention.

FIG. 2 is a sectional view of a porous material according to an embodiment of the present invention.

FIG. 3 is a sectional view of the material according to FIG. 1.

FIG. 4 is a sectional view of a seat according to an embodiment of the present invention.

FIG. 5 is a sectional view of the material according to an embodiment of the present invention.

FIG. 6 is a top-side view of the spacer fabric according to another embodiment of the present invention.

FIG. 7 is an underside view of the spacer fabric according to FIG. 6.

### DETAILED DESCRIPTION

Hereinafter, embodiments of the present invention will be described with reference to the attached drawings.

According to an embodiment of the present invention, a material 10 is provided. The material 10 includes a porous material layer 15. Additionally, as shown in FIG. 5, the material 10 can also include a cover layer 30. The cover layer 30 may be porous and may include a poly-vinyl chloride polymer coated material, leather, body cloth fabric, a thermoplastic olefin coated material, a polyurethane coated material, or any other suitable material. The porous material layer 15 may be a reticulated foam, a nonwoven textile, or preferably a spacer fabric. A material 10, according to an embodiment of the invention includes a cover layer 30 and a spacer fabric 20. The spacer fabric 20 comprises a first 22 and second fabric 26 layer, and a pile layer 24. The cover layer 30 is laminated onto the spacer fabric 20.

A seat, according to another embodiment of the invention, includes a cover layer 30, and a porous material 15. The porous material 15 is positioned under the cover layer 30 and the cover layer 30 is laminated on the porous material 15.

A material 10, according to another embodiment of the present invention, includes a spacer fabric 20 covered by a cover layer 30. The cover layer 30 is laminated to the spacer fabric 20 so that the top surface of the material 10 is substantially smooth.

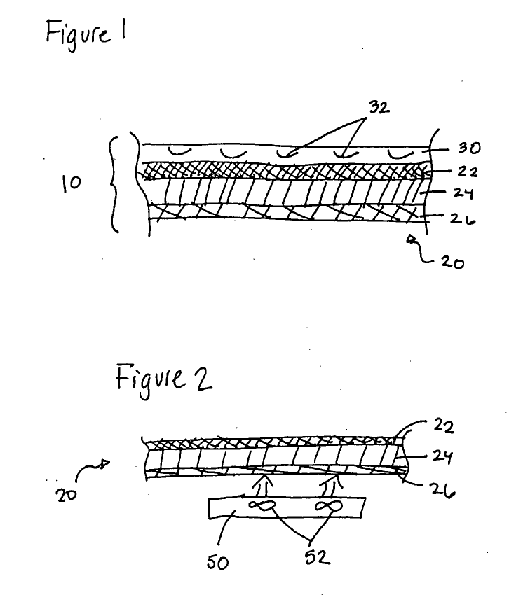

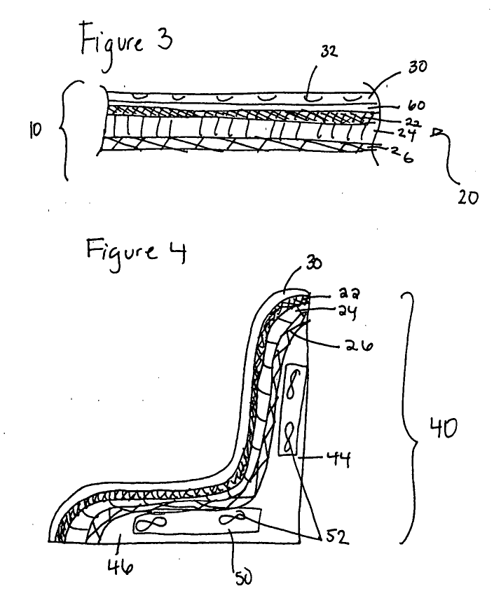

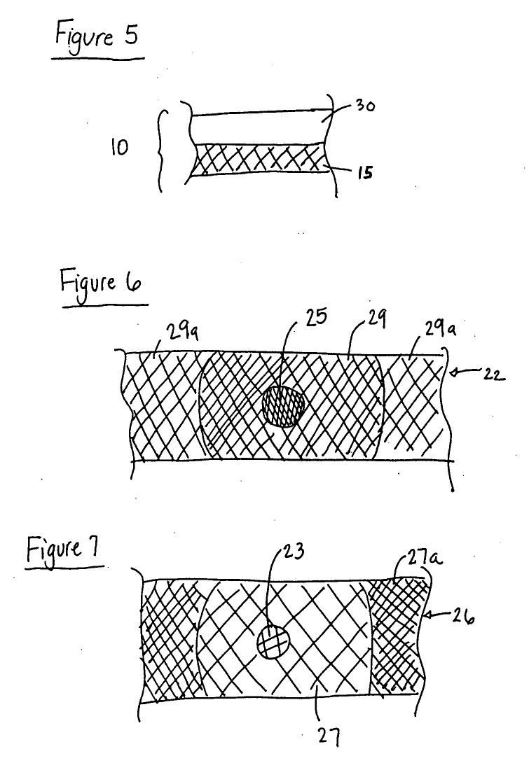

According to an alternative embodiment of the present invention, the porous material layer 15 may comprise a spacer fabric 20. The spacer fabric 20, as shown in FIGS. 1 and 2, may include a first fabric layer 22, a second fabric layer 26 and a pile layer 24 which connects the first 22 and second 26 fabric layers. The fabric layers 22, 26 are made of a knitted material. The pile layer 26 is composed of 100% by weight of monofilament yarn. The spacer fabric layer 20 may be produced on a multi-guide bar, double needle bar, Raschel type knitting machine, or by any other suitable loom or knitting machine.

The spacer fabric layer 20 is configured to allow air to flow through the material and remove or evaporate moisture from an outer surface. The cover layer 30 is attached to the first fabric layer 22. The cover layer 30 may be a continuous material and include perforations 32 which allow for fluid (i.e. air, moisture and / or climate controlled forced air) to flow through the layer. The perforations shown 32 in the drawings are exemplary only and may be in different locations or sizes.

The spacer fabric 20 may be approximately 4 to 60 mm in thickness. According to another embodiment of the invention, the thickness of the spacer fabric may be 6 to 30 mm. Preferably, the thickness of the spacer fabric 20 is about 8 to about 12 mm. The denier of the pile yarn may be approximately 30 to 1200 denier. According to another embodiment of the invention, the denier of the pile yarn may be 100 to 900. Preferably, the denier of the pile yarn is about 150 to about 600.

The first fabric layer 22 of the spacer fabric 20 may be of any configuration, but is preferably a close-knit arrangement. The second fabric layer 26 is preferably a open mesh, honeycomb surface structure, but may be configured to be any suitable structure. The denier of the yarn in the first and second fabric layers may be 40 to 1200. According to another embodiment of the invention, the denier of the yarn in the first and second fabric layers may be 100 to 900. Preferably, the denier of the yarn in the first and second fabric layers is about 150 to about 600. The denier of the yarn in the first layer may differ from the denier of the yarn in the second layer.

The spacer fabric 20 is an air permeable fabric. The spacer fabric 20 may also increase the cushioning feel to an occupant or user of the fabric and may repel and/or absorb moisture on one or both sides-of the fabric 20. The spacer fabric 20 may be configured so the first fabric layer 22 has an air permeability different from the air permeability of the second fabric layer 26.

According to an embodiment, the second fabric layer 26 includes a first portion 23 for air supply or air removal which is made with the greatest possible air permeability (shown in FIG. 7). The first fabric layer 22 may include a second portion 25 that is made with reduced air permeability, as shown in FIG. 6. The second portion 25 is aligned opposite the first portion 23. According to an embodiment of the invention, both the first 23 and second 25 portions are generally circular. The second portion 25 is adjoined by a third portion 29 which has increased air permeability as the distance increases from the second portion 23. The third portion 29 and adjacent portions 29a are generally annular and continue to increase in air permeability the farther from the second portion 23. As shown in FIG. 7, the second fabric layer 26 may include a fourth portion 27 that decreases in air permeability and is generally an annular shape around the first portion 23. The fourth portion 27 and adjacent portions 27a decrease in air permeability the farther from the first portion 23. The portions 23, 25, 27, 29 may be defined by cut edges. The different air permeabilities allow air flow to pass through the second fabric layer 26, at or near the first portion 23 and pass through the pile 24 and first fabric layer 22 with approximately uniform distribution of the air flow. Of course, as will be recognized by those skilled in the art, the air flow direction may be reversed and/or the location of the portions 23, 25, 27, 29 may be switched in order to have equal flow distribution with a change in direction of flow. The first 23 and second portions 25 may also be any other configuration or shape suitable for air circulation such as, for example, rectangular. As will be appreciated by those skilled in the art, any suitable type of spacer fabric may be used.

According to an embodiment, the second fabric layer 26 is configured to be adjacent an air circulation system 50, as shown in FIG. 2. The air circulation system 50 is not part of the spacer fabric 20, but is a separate system. The air flow system 50 may comprise electric fans 52, such as, for example, the system found in U.S. Pat. Nos. 5,626,021 or RE 38,128 (both patents are hereby incorporated by reference herein in their entirety). Of course, any other suitable air circulation system 50 may be used. The air flow system 50 may cool or heat the fabric 20 or the object attached to the fabric 20, such as a seat, bed, backpack, or any other suitable object. The air flow system 50 may force air through the fabric and blow the air through the second fabric layer 26, distributed through the pile layer 24 and out and through the first fabric layer 22.

As mentioned above, the porous material 15 may comprise a reticulated foam or a nonwoven textile. The cover layer 30 attaches to one side of the porous material 15. The cover layer 30 is attached to a side of the porous material layer 15 by lamination. The cover layer 30 may be laminated onto the porous material layer 15 by any suitable method such as, for example, thermoplastic laminates, thermoset processes, cold laminating, or a UV curable adhesion system.

In the case of the porous material layer 15 comprising a spacer fabric 20, the cover layer 30 is attached to the first fabric layer 22 on a side adjacent to the pile layer 24. The cover layer 30 may be attached to the first fabric layer 22 by any suitable mechanism, such as by sewn seams, fasteners, adhesives, etc.

In one embodiment, a laminate 60 is applied to and coated on an underside of the cover layer fabric 30 which is then positioned on the first fabric layer 22. The material 10 may then be held under weight for approximately twenty-four hours to properly seal the cover layer 30 to the first fabric layer 22 and, thus, the spacer fabric 20. The same basic process may be employed for laminating the cover layer 30 to other embodiments of the porous material layer 15.

According to an embodiment of the invention, the laminate 60 may be formed by the use of a solvent born, flame retardant polyurethane adhesive, or any other suitable adhesive. According to one embodiment of the present invention, the laminate 60 may be applied to the cover layer 30 by hot melt spun adhesive or by spraying the adhesion onto, the underside of the cover layer 30 by a spray nozzle or oscillating disk. The spray nozzle or oscillating-disk passes along the length of the material to coat the cover layer 30 and then the cover layer 30 is pressed onto the porous material layer 15. Before a laminate 60 is applied to the cover layer 30, the cover layer 30 and porous material layer 15 is heat set at approximately 400 degrees Fahrenheit.

According to another embodiment, the cover layer 30 may be further secured to the porous material layer 15 by a variety of different welding processes, i.e., a radio frequency (RF) welding process, thermal heat sealing, ultrasound and dielectric sealing. For example, the materials can be RF welded along the perimeter of the material 10. The RF weld may be applied with utilizing a die. The material 10 may also be sewn along the perimeter after the cover layer 30 is laminated to the porous material layer 15.

The material 10 effectively simulates the compressibility and resiliency of conventional spacer fabric and plastic foam materials such as polyurethane. In addition, the material 10 provides wear reduction, improved seam strength, reduced edge fraying and ease of production.

The material 10 has improved wear characteristics. The cover layer 30 has less mobility in comparison to the porous material layer 15. In other words, according to the present invention, there is less relative movement between the cover layer 30 and the porous material layer 15. The cover layer 30 does not slide relative to the adjoining porous material layer 15. Accordingly, the life of the fabric 10 is increased. Furthermore, the seam strength of the fabric 10, as may be tested by a needle pullout test, is increased due to the attachment of the cover layer 30 to the porous material layer 20.

According to another embodiment, as shown in FIG. 4, a seat 40 for an automobile, watercraft, or any other type of seat 40 is provided. The seat 40 may include a seat back 44 and/or a seat bottom 46. The seat 40 includes a cover layer 30 which is integrated onto a surface of the seat back 44 and/or seat bottom 46 adjacent to an occupant (not shown). A porous material is positioned adjacent to the cover layer 30 on a side of the cover layer 30 opposite the occupant. The porous material may be a reticulated foam, a nonwoven textile, or a spacer fabric and attached onto the cover layer 30. According to FIG. 4, a spacer fabric 20 is shown. The spacer fabric 20 is similar to that described above and includes a first fabric layer 22, a second fabric layer 26 and a pile layer 24. The use of the material 10 including a cover layer overlying a porous material layer for the seat covering allows for air flow and/or removal or evaporation of moisture from the exposed surface of the seat bottom and back adjacent to an occupant.

The,seat 40, according to an embodiment of the invention, may further include an air circulation flow device 50. The air flow device 50 may include fans 52. The fans 52 are shown in FIG. 4 in exemplary locations only and may be positioned in various, suitable locations. The air flow device 50 may be the Amerigon climate control system, for example the system disclosed in U.S. Pat. Nos. 5,626,021 or RE 38,128, or any other suitable air flow/removal system.

It is to be understood that any suitable spacer fabric may be used as the porous material in the material 10 and the seat 40. In addition, different combinations of cover layers 30 and ventilated materials 20 may be used for the material 10 and seat.

According to an embodiment of the present invention, the material 10 exhibits many improved characteristics. The material 10 resists compression and collapse. As a result, air flow through the material 10 can be maintained over a wide range of loadings. When the material is used as a seating surface, the improved compression and bend performance may prevent or reduce the collapse of the seating surface into the underlying air manifolds thereby preventing patterning in these passages and preserving the air transport capabilities of the material. Furthermore, when used in combination with a forced air system, the system noise can be reduced due to a reduction in back pressure on the system fan caused by constricted air flow.

The improved characteristics of the present invention, may be measured and specified in a number of different ways. For example, according to an embodiment of the present invention, the material 10 provides reduced compression for a given loading applied perpendicular to the surface of the material. For example, according to an embodiment of the invention, the material 10 exhibits less than a 15 percent reduction of thickness in response to a load of 150 Newtons. Further by way of example, the material 10 exhibits less than a 10 percent reduction of thickness in response to a load of 100 Newtons.

For example, a specific sample of laminated space fabric according to an embodiment of the present invention has an unloaded thickness of 10 mm. When a load is applied to the sample in a direction generally perpendicular to the attachment side surface of the material 10, the thickness of the material gradually reduces at a generally linear rate. The thickness of the fabric is reduced from about 9 mm to about 8 mm as the load increases from 25 to 175 Newtons. More specifically, for the 10 mm thick sample of the material 10 according to an embodiment of the present invention, the material is configured to resist a reduction of thickness greater than 20 percent for applied loads less than about 150 Newtons.

The material 10, according to another embodiment of the invention, is configured to exhibit Hookean behavior. The material 10 can offer a linear response to loading over a tested range. On the contrary, other conventional materials display asymptotic behavior and will undergo no further compression; resulting in incompressible solids.

According to an embodiment of the present invention, the air flow through the fabric in two dimensions (i.e, parallel and perpendicular to the laminated surface) may be improved.

A material 10 according to an embodiment of the present invention was tested to determine the ability of the material to allow airflow while under load. Accordingly, as shown in Table 1 below, a material was subjected to a varying amount of load to produce a variety of different thicknesses of material. The airflow through the material was determined for a constant air pressure (200 mBar). The required force to be applied to the material 10 to produce the displacement or reducing in thickness, could be determined according to the Hook's constant for the material. Due to the improved configuration, the material 10 according to an embodiment of the present invention will maintain air passages at loadings far in excess of those offered by the other conventional materials. As can be seen in Table 1, the exemplary material 10 is configured to have an air flow in the range of 80 to 275 CFM under pressure in the range of about 40 to about 200 Pa, when compressed to a thickness of 7.11 mm. Alternatively, the exemplary material 10 allows for an air flow in range of approximately 80 to about 210, under pressure in the range of about 40 to 200 Pa when compressed to a thickness of 6.1 mm.

[image]

As shown in Table 1, characteristics for exemplary material compressed to both 4.8 mm and 3.8 mm thicknesses are disclosed. For the 10 mm thick exemplary material 10 used to obtain the results of Table 1, it should be noted that for an approximately 50 percent reduction of thickness of the material there is only an approximately 50 percent reduction in air flow from approximately 250 cfm to 130 cfm at an applied pressure of 200 mBar.

The improved characteristics of the present invention may be measured in an alternative format. For example, when an exemplary laminated space fabric is placed under a defined pressure of approximately 200 mBar, the material 10 will have a reduction in thickness as determined by Hook's constant for the material. As a result, if a constant displacement is applied, the exemplary material 10 will undergo a higher state of force compared to other, conventional laminated fabrics.

Thus, an advantage of the material 10 is that it allows air passage at force loadings far in excess of those offered by other, conventional materials. For example, under a load of 200 mBar, the air flow of the material 10 ranges from approximately 275 to 75 CFM, while under a loading of approximately 50 to 300 Lb force. In comparison, a conventional reticulated foam material ranges from approximately 160 to 50 CFM under a loading of 0 to 50 Lb force, as shown in Table 2.

[image]

As mentioned above, the material 10 according to an embodiment of the present invention, exhibits increased resistance to compression. Therefore, as shown in Table 3, the amount of force applied to the fabric to achieve a 70 percent reduction in thickness is significantly greater for a material according to the present invention than for a conventional foam or spacer material. Table 3 discloses the amount of force required to achieve a 70% reduction in thickness for a fabric of a given thickness. For example, for fabrics in a thickness range of 20 to 40 mm, the material 10 would need to be subject to approximately 90 to 110 pounds force in order to obtain the 70% reduction.

[image]

In another embodiment, the pile layer 24 is configured to have an air flow rate of 200 to 300 cfm while the material 10 is compressed to the point of maintaining 40 % original loft. At this air flow rate, the material 10 is under a pressure of approximately 200 mBar. More specifically, the flow rate is in the range of 200 to 250 cfm. Preferably, the air flow rate is approximately 214 cfm.

The material 10 according to an embodiment of the invention, exhibits improved aging and wear resistance characteristics. The exemplary material has displayed better abrasion resistance than reticulated foam. For example, when subjected to abrasion cycle testing on a Wyzenbeek cycle tester, the exemplary material 10 completed a test cycle of about 30,000 cycles.

According to another embodiment of the present invention, the material 10 may also have improved circular bend flex resistance or the resistance to compression and bending. A sample of a material 10 according to an embodiment of the present invention was subjected to a circular bend flex test. The test demonstrated that a force of 6.40 to 8.40 pounds was required to deform the material 10 and press the material 10 through a ring (the circular bend flex test). The circular bend flex test results are shown in Table 4.

TABLE 4
Circular Bend Flex Test

| Inventive | “LB” | “LB” | “LB” | “LB” | “LB” |
|---|---|---|---|---|---|
| Material | 8.24 | 8.40 | 8.36 | 8.02 | 7.98 |
| C-Peak | 7.00 | 7.32 | 7.56 | 7.14 | 7.20 |
| (60 psi) | 6.60 | 6.86 | 7.36 | 6.96 | 6.80 |
| | 6.70 | 6.98 | 6.86 | 6.80 | 6.40 |
| | 6.44 | 6.70 | 6.74 | 6.64 | 6.50 |

In another embodiment, the fibers of the pile layer 24 can each have a tenacity in the range of 40 to 50 cN/tex. More specifically, the fibers of the pile layer 24 can have a tenacity of approximately 43 to 48 cN/tex. Preferably, the fibers of the pile layer 24 have a tenacity of approximately 46 cN/tex. In one embodiment, the fibers of the pile layer 24 can each have a diameter in the range of approximately 0.07 to 0.11 mm. More specifically, the fibers of the pile layer 24 can have a diameter in the range of approximately 0.08 to 0.10 mm. Preferably, the fibers of the pile layer 24 have a diameter of approximately 0.09 mm.

In yet another embodiment, the material 10 can have a specific compactability in the range of 35 to 100 cm³. The specific compactability can be tested using the standard ASTM testing method designated D 6478-02. The ASTM International Designation D 6478-02 “Standard Test Method for Determining Specific Packability of Fabrics Used in Inflatable Restraints” is incorporated by reference herein. The ASTM testing method is modified so that a specimen of the material 10 is placed into the testing box in a single layer and is not folded. The compactability of a material 10 can be a factor in the design of products with spatial constraints. More specifically, the material 10 can have a specific compactability in the range of 40 to 90 cm³. Preferably, the specific compactability of the material 10 is in the range of 45 to 80 cm³.

Given the disclosure of the present invention, one versed in the art would appreciate that there may be other embodiments and modifications within the scope and spirit of the invention. For example, the scope of the present invention includes a material 10 structure having multiple layers of porous material. For example, the material 10 may include one or more layers of reticulated foam in combination with one or more layers of spacer material. Other suitable combinations of porous material layers would also fall within the scope of the present invention. Furthermore, all modifications attainable by one versed in the art from the present disclosure within the scope and spirit of the present invention are to be included as further embodiments of the present invention. The scope of the present invention is to be defined as set forth in the following claims.

1.-25. (canceled)

26. A laminated material comprising:
a cover layer, and
a porous material layer,
wherein the cover layer is laminated directly onto the porous material layer.

27. The laminated material of claim 26, wherein the porous material layer comprises a spacer fabric including a plurality of fabric layers.

28. The laminated material of claim 26, wherein the cover layer comprises leather.

29. The laminated material of claim 26, wherein a stitch is sewn along edges of the cover layer and the porous material layer.

30. The laminated material of claim 26, further comprising a flame retardant adhesive for laminating the cover layer to the porous material layer.

31. The laminated material of claim 26, further comprising a solvent-based flame retardant polyurethane adhesive for laminating the cover layer to the porous material layer.

32. The laminated material of claim 26, wherein the cover layer is laminated to the porous material layer by a thermoset process.

33. The laminated material of claim 26, wherein the cover layer is laminated to the porous material layer by a cold curing adhesive.

34. The laminated material of claim 26, wherein the cover layer is laminated to the porous material layer by a UV curable adhesive.

35. The laminated material of claim 26, wherein the cover layer is welded to the porous material layer by radio frequency welds along the perimeter of the layer.

36. The laminated material of claim 26, wherein the cover layer is welded to the porous material layer by ultrasonic welds along the perimeter of the layer.

37. The laminated material of claim 26, wherein the cover layer is welded to the porous material layer by thermal welds along the perimeter of the layers.

38. The laminated material of claim 26, wherein the cover layer is welded to the porous spacer material layer by dielectric welds along the perimeter of the layers.

39. A laminated material comprising:
a cover layer, and
a spacer fabric comprising:
a first fabric layer,
a pile layer, and
a second fabric layer,
wherein the cover layer is laminated directly onto the spacer fabric.

40. The laminated material of claim 39, wherein the cover layer is laminated to the first fabric layer.

41. The laminated material of claim 39, wherein the cover layer comprises leather.

42. The laminated material of claim 39, wherein the pile layer comprises 100% by weight polyester monofilament fiber.

43. The laminated material of claim 39, wherein the pile layer comprises a yarn having a size is in the range of 30 to 1200 denier.

44. The laminated material of claim 39, wherein the denier of yarn in said first fabric layer is in the range of 40 to 1200 denier.

45. The laminated material of claim 39, wherein said first and said second fabric layers comprise multifilament flat or textured yarns.

46. The laminated material of claim 39, wherein the thickness of the spacer fabric is approximately 4 to 60 mm.

47. The laminated material of claim 39, wherein the air permeability of the first fabric layer is different than the air permeability of the second fabric layer.

48. The laminated material of claim 39, wherein the pile layer connects the first fabric layer and the second fabric layer together.

49. The laminated material of claim 39, wherein the second fabric layer comprises a honeycomb pattern.

50. The laminated material of claim 39, wherein the spacer fabric is configured to distribute air flow through the spacer fabric to heat or cool the cover layer.

51. A seat comprising:
a cover layer, and
a porous material
wherein the cover layer is laminated directly onto the porous material.

52. The seat of claim 51, wherein the porous material comprises a spacer fabric.

53. The seat of claim 51, wherein the spacer fabric comprises:
a first fabric layer,
a pile layer, and
a second fabric layer.

54. The seat of claim 51, wherein the cover layer comprises leather.

55. A material including a spacer fabric covered by a cover layer, wherein the cover layer is laminated directly onto the spacer fabric so that the top surface of the material is substantially smooth except for secondary patterning on the cover layer so that the spacer fabric layer substructure is not apparent.

56. A laminated material comprising:
a cover layer, and
a porous material layer,
wherein the cover layer is laminated directly onto the porous material layer and wherein the porous material layer comprises a plurality of layers at least one of the layers being a layer of spacer fabric; wherein the layers of the porous material layer are laminated together.
